(19) United States
(12) Patent Application Publication
(10) Pub. No.: US 2025/0067885 A1
(43) Pub. Date: Feb. 27, 2025

(54) DETECTOR AND MEDICAL DEVICE INCLUDING THE SAME

(71) Applicant: Shanghai United Imaging Healthcare Co., Ltd., Shanghai (CN)

(72) Inventor: Zhenjie Han, Shanghai (CN)

(21) Appl. No.: 18/814,582

(22) Filed: Aug. 25, 2024

(30) Foreign Application Priority Data
Aug. 24, 2023 (CN) 202322289899.0

(51) Int. Cl. G01T 1/202

(52) U.S. Cl. CPC G01T 1/202

(57) ABSTRACT

A detector includes a plurality of crystal arrays and a plurality of photoelectric sensor arrays stacked in the third direction. Each of the crystal arrays includes a plurality of crystal array units arranged in an array in a plane defined by a first direction and a second direction, and each of the crystal array units includes at least one crystal. Each of the crystal arrays has a coupling surface perpendicular to the third direction. The first direction, the second direction, and the third direction are perpendicular to one another. Each of the photoelectric sensor arrays includes a plurality of photoelectric sensor array units arranged in an array in the plane defined by the first direction and the second direction, and each of the photoelectric sensor array units includes at least one photoelectric sensor. The photoelectric sensor array is coupled to the crystal array through the coupling surface.

### CROSS-REFERENCE TO RELATED APPLICATIONS

This application claims priority to Chinese patent application No. 202322289899.0, filed Aug. 24, 2023, and entitled “Detector and Medical Device Including the Same”, which is hereby incorporated by reference in its entirety.

### TECHNICAL FIELD

The present disclosure relates to the field of medical device technologies, and in particular to a detector and a medical device including the same.

### BACKGROUND

A detector is an important component of a molecular imaging medical device. Material combination, structural design, and performance of the detector directly affect the application of the molecular imaging medical device to clinical and scientific research. The quality of the detector directly determines the quality of the molecular imaging medical device.

Generally, the detector includes a crystal unit, a photoconverter, and a backend electronic circuit. In a traditional detector structure, generally, a crystal array is directly coupled to the photoconverter. In order to ensure sufficient sensitivity, a crystal of the detector is generally required to have a certain length. However, an excessively long crystal may directly affect the time of flight (TOF) limit value of the detector, and the depth of interaction (DOI) of a photon cannot be accurately detected, thereby affecting the spatial resolution of an image.

### SUMMARY

In one aspect of the present disclosure, a detector is provided, including:
a plurality of crystal arrays each including a plurality of crystal array units arranged in an array in a plane defined by a first direction and a second direction, each of the crystal array units including at least one crystal, each of the crystal arrays having a coupling surface perpendicular to a third direction, wherein the first direction, the second direction, and the third direction are perpendicular to one another; and
a plurality of photoelectric sensor arrays stacked with the plurality of crystal arrays in the third direction, each of the photoelectric sensor arrays including a plurality of photoelectric sensor array units arranged in an array in the plane defined by the first direction and the second direction, each of the photoelectric sensor array units including at least one photoelectric sensor, and the photoelectric sensor array being coupled to the crystal array through the coupling surface.

In some embodiments, the plurality of photoelectric sensor array units are in one-to-one correspondence to the plurality of crystal array units, and each of the photoelectric sensor array units has a boundary not exceeding a boundary of the corresponding crystal array unit.

In some embodiments, the photoelectric sensor array unit and the crystal array unit each have equal dimensions in the first direction and the second direction.

In some embodiments, each of the crystal array units includes a single crystal, each of the photoelectric sensor array units includes a single photoelectric sensor, and a dimension of the crystal is equal to that of the photoelectric sensor.

In some embodiments, each of the crystal array units includes a plurality of crystals arranged in an array in the plane defined by the first direction and the second direction, and each of the photoelectric sensor array units includes a plurality of photoelectric sensors arranged in an array in the plane defined by the first direction and the second direction. A number of the crystals in each of the crystal array units is greater than that of the photoelectric sensors in each of the photoelectric sensor array units.

In some embodiments, one of the photoelectric sensor arrays is stacked between each two adjacent crystal arrays.

In some embodiments, surfaces of each of the crystal array units except the coupling surface are provided with a reflection structure.

In some embodiments, the reflection structure extends to the photoelectric sensor array unit along the third direction.

In some embodiments, the reflection structure extends between two adjacent photoelectric sensor array units along the third direction and is flush with a side face of the photoelectric sensor array unit away from the crystal array unit.

In some embodiments, wherein dimensions of the crystal in the first direction, the second direction, and the third direction each range from 0.5 mm to 5 mm.

In some embodiments, a number of the photoelectric sensor array units is equal to that of the crystal array units, and a dimension of the photoelectric sensor is not less than that of the crystal.

In some embodiments, a pair of the photoelectric sensor arrays is arranged between at least one pair of adjacent crystal arrays. The pair of photoelectric sensor arrays are arranged back to back.

In another aspect of the present disclosure, a medical device including a detector is provided. The detector includes:
a plurality of crystal arrays each including a plurality of crystal array units arranged in an array in a plane defined by a first direction and a second direction, each of the crystal array units including at least one crystal, the plurality of crystal arrays being stacked in a third direction, wherein the first direction, the second direction, and the third direction are perpendicular to one another; and
at least one photoelectric sensor array arranged between at least two adjacent crystal arrays in the third direction, the at least one photoelectric sensor array including a plurality of photoelectric sensor array units arranged in an array in the plane defined by the first direction and the second direction, each of the photoelectric sensor array units including at least one photoelectric sensor.

The crystals are configured to receive gamma photons, and the photoelectric sensors are each configured to detect optical signals generated by interaction of the gamma photons and the crystals.

In some embodiments, dimensions of the crystal in the first direction, the second direction, and the third direction each range from 0.5 mm to 5 mm.

In some embodiments, each of the crystal arrays has a coupling surface perpendicular to the third direction, and the crystal array is coupled to the at least one photoelectric sensor array through the coupling surface.

In some embodiments, surfaces of each of the crystal array units except the coupling surface are each provided with a reflection structure.

In some embodiments, the reflection structure extends along the third direction to the photoelectric sensor array unit.

In some embodiments, the at least one photoelectric sensor array includes a plurality of photoelectric sensor arrays. The plurality of crystal arrays and the plurality of photoelectric sensor arrays are alternately stacked.

In some embodiments, the at least one photoelectric sensor array includes a pair of photoelectric sensor arrays arranged between one pair of adjacent crystal arrays. The pair of photoelectric sensor arrays are arranged back to back.

In yet another aspect of the present disclosure, a detector is provided, which includes a plurality of crystal arrays and a plurality of photoelectric sensor arrays. The plurality of crystal arrays and the plurality of photoelectric sensor arrays are alternately stacked in a direction, and each of the crystal arrays is coupled to one of the photoelectric sensor arrays adjacent thereto.

Details of one or more embodiments of the present disclosure are set forth in the following accompanying drawings and descriptions. Other features, objectives, and advantages of the present disclosure become obvious with reference to the specification, the accompanying drawings, and the claims.

### BRIEF DESCRIPTION OF THE DRAWINGS

FIG. 1 is a schematic structural diagram showing a stack of a crystal array and a photoelectric sensor array in a detector according to an embodiment of the present disclosure;

FIG. 2 is a schematic structural diagram showing a stack of a plurality of crystal arrays and a plurality of photoelectric sensor arrays in a detector according to an embodiment of the present disclosure;

FIG. 3 is a schematic structural diagram showing a stack of a crystal array and a photoelectric sensor array in a detector according to another embodiment of the present disclosure;

FIG. 4 is a schematic structural diagram showing a stack of a plurality of crystal arrays and a plurality of photoelectric sensor arrays in a detector according to another embodiment of the present disclosure;

FIG. 5 is a schematic structural diagram showing a stack of a plurality of crystal arrays and a plurality of photoelectric sensor arrays in a detector according to yet another embodiment of the present disclosure; and

FIG. 6 is a schematic structural diagram showing an arrangement of a reflection structure on a crystal array unit in a detector according to an embodiment of the present disclosure.

### DETAILED DESCRIPTION

In order to make the above objectives, features and advantages of the present disclosure more obvious and understandable, specific implementations of the present disclosure are described in detail below with reference to the accompanying drawings. In the following description, many specific details are set forth in order to fully understand the present disclosure. However, the present disclosure can be implemented in many other ways different from those described herein, and those skilled in the art can make similar improvements without departing from the connotation of the present disclosure. Therefore, the present disclosure is not limited by specific embodiments disclosed below.

In the description of the present disclosure, it is to be understood that the orientation or position relationships indicated by the terms “central”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise”, “axial”, “radial”, “circumferential”, and the like are based on the orientation or position relationships shown in the accompanying drawings and are intended to facilitate the description of the present disclosure and simplify the description only, rather than indicating or implying that the apparatus or element referred to must have a particular orientation or be constructed and operated in a particular orientation, and therefore are not to be interpreted as limiting the present disclosure.

In addition, the terms “first” and “second” are used for descriptive purposes only, which cannot be construed as indicating or implying a relative importance, or implicitly specifying the number of the indicated technical features. Therefore, the features defined with “first” and “second” may explicitly or implicitly include at least one feature. In the description of the present disclosure, the term “a plurality of” means at least two, such as two or three, unless otherwise defined explicitly and specifically.

In the present disclosure, unless otherwise specified and defined explicitly, the terms “mount”, “connect”, “join”, and “fix” should be understood in a broad sense, which may be, for example, a fixed connection, a detachable connection, or an integral connection; a mechanical connection or an electrical connection; or a direct connection, an indirect connection via an intermediate medium, an internal connection between two elements, or interaction between two elements. Those of ordinary skill in the art can understand specific meanings of these terms in the present disclosure according to specific situations.

In the present disclosure, unless otherwise explicitly specified and defined, the expression a first feature being “on” or “under” a second feature may be the case that the first feature is in direct contact with the second feature, or the first feature is in indirect contact with the second feature via an intermediate medium. Furthermore, the expression of the first feature being “over”, “above” and “on top of” the second feature may be the case that the first feature is directly above or obliquely above the second feature, or only means that the level of the first feature is higher than that of the second feature. The expression of the first feature being “below”, “underneath” or “under” the second feature may be the case that the first feature is directly underneath or obliquely underneath the second feature, or only means that the level of the first feature is lower than that of the second feature.

It is to be noted that when one element is referred to as being “fixed to” or “arranged on” another element, it may be directly disposed on the other element or an intermediate element may exist. When one element is considered to be “connected to” another element, it may be directly connected to the another element or an intermediate element may co-exist. The terms “vertical”, “horizontal”, “upper”, “lower”, “left”, “right”, and similar expressions used herein are for illustrative purposes only and do not represent only implementation.

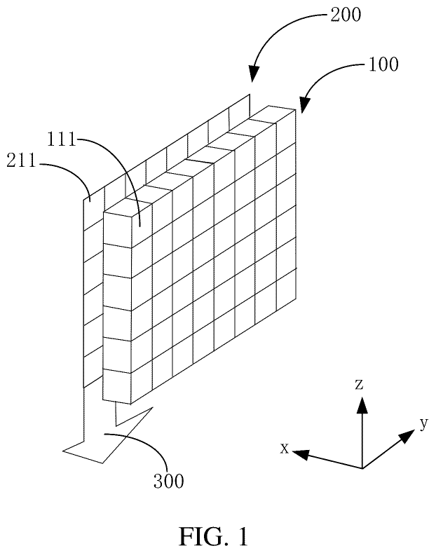

Referring to FIG. 1 to FIG. 4, an embodiment of the present disclosure provides a detector. The detector includes a plurality of crystal arrays 100 and a plurality of photoelectric sensor arrays 200. The crystal array 100 includes a plurality of crystal array units 110. The plurality of crystal array units 110 are arranged in an array in a plane defined by a first direction y and a second direction z. Each of the crystal array units 110 includes at least one crystal 111. The photoelectric sensor array 200 includes a plurality of photoelectric sensor array units 210. The plurality of photoelectric sensor array units 210 are arranged in an array in the plane defined by the first direction y and the second direction z. Each of the photoelectric sensor array units 210 includes at least one photoelectric sensor 211. The plurality of crystal arrays 100 are stacked in a third direction x, and each of the crystal arrays has a coupling surface 101 perpendicular to the third direction x. The photoelectric sensor array 200 is coupled to the crystal array 100 through the coupling surface 101. The first direction y, the second direction z, and the third direction x are perpendicular to one another. The numbers and dimensions of the photoelectric sensor array unit 210 and the crystal array unit 110 are both equal, and the dimension of the photoelectric sensor 211 is not less than that of the crystal 111.

In the detector above, the crystal array 100 is configured to convert incident gamma photons into fluorescent photons. By arranging the plurality of crystal array units 110 of the crystal array 100 in an arrayed manner, the dimension of the crystal can be reduced, thereby increasing the sensitivity and resolution of the detector. The crystal array 100 is coupled to the photoelectric sensor array 200 so that fluorescence generated by the interaction of the gamma photons and the crystal 111 is converted into electrical signals by the photoelectric sensor array 200. The number of the photoelectric sensor array unit 210 is the same as that of the crystal array unit 110. Compared to traditional longer crystals, the depth information can be artificially separated, so that the photoelectric sensor array units 210 can directly parse position information of the interaction of the gamma photons and the crystal on the shorter crystal array unit 110, which reduces subsequent data correction and directly obtains depth information of the gamma photons incident into the crystal 111. The multi-layer crystal arrays 100 shorten the propagation time of the gamma photons in the crystals 111 and increase the total propagation length of the gamma photons, which improves the temporal resolution of the detector while maintaining a certain sensitivity performance. By setting the dimension of the crystal 111 to be no larger than the size of the photoelectric sensor 211, so that the dimension of the crystal 111 is relatively small, thereby reducing an optical path of the fluorescence photons and the TOF value of the detector and improving the sensitivity and detection efficiency of the detector. At the same time, the number of the photoelectric sensor 211 is smaller or consistent with the number of the crystal 111 to reduce material costs.

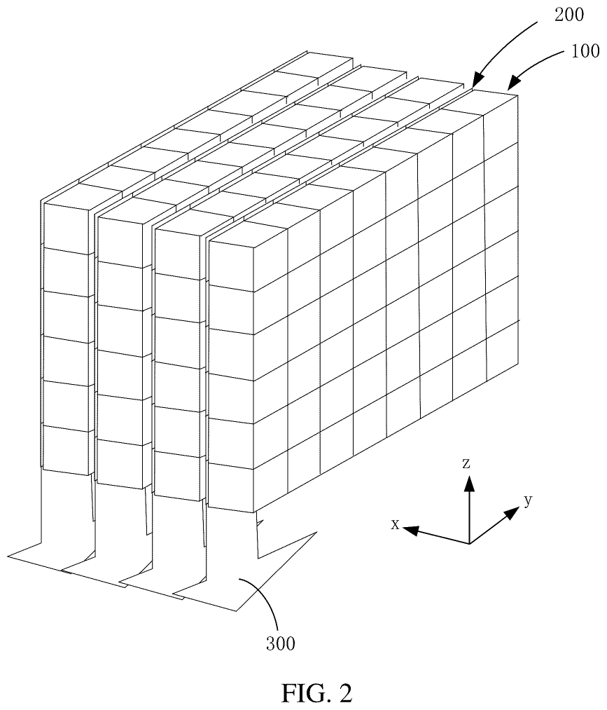

As shown in FIG. 2, in some embodiments, the first direction is a direction y, the second direction is a direction z, and the third direction is a direction x. Coupling means bonding a light exit surface of the crystal array to the photoelectric sensor array through a photoconductive medium (such as silicone grease or glue), so that the optical signal can be propagated more efficiently. The crystal 111 converts the energy of high-energy particles into light energy when the gamma photons enter the crystal. The crystal 111 may be a lutetium yttrium silicate crystal (LYSO crystal), a bismuth germanate crystal (BGO crystal), a sodium iodide crystal (NaI crystal), or a crystal of various other materials. The crystal may be in the shape of a cylinder, a square, a rectangle, etc. The photoelectric sensor 211 may be a photomultiplier tube, a silicon photomultiplier (SiPM) array panel, etc.

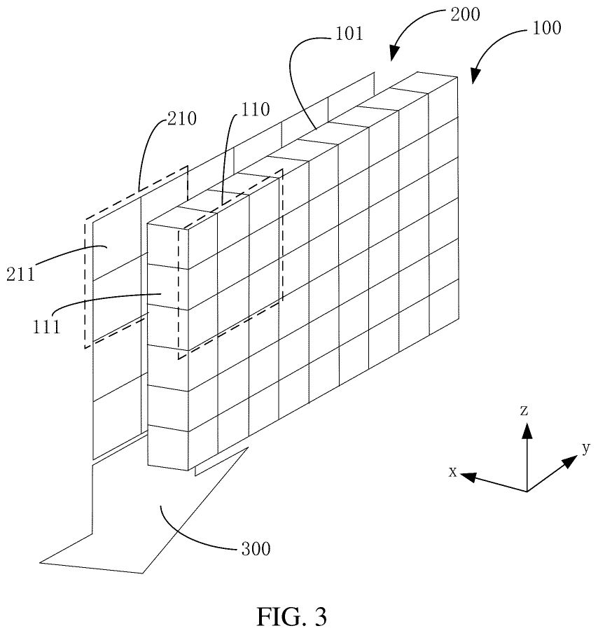

In some embodiments, the plurality of photoelectric sensor array units are in one-to-one correspondence to the plurality of crystal array units, and the boundary of the photoelectric sensor array unit does not exceed the boundary of the corresponding crystal array unit. For example, an optical splitting structure may be arranged between adjacent crystals in the crystal array unit, so that the fluorescence photons excited in the crystal in the crystal array unit which is not covered by the corresponding photoelectric sensor array unit enter the crystal covered by the photoelectric sensor array unit, and then can be received by the photoelectric sensor array unit. The optical splitting structure may include, for example, a reflective film or other light-isolating material provided between adjacent crystals. In the exemplary embodiments shown in FIG. 1 and FIG. 3, the boundary of the photoelectric sensor array unit 210 is aligned with the boundary of the corresponding crystal array unit 110, so that the photoelectric sensor array unit 210 can directly parse the position information of the corresponding crystal array unit 110, which reduces subsequent data correction and improves detection efficiency of the detector.

Dimensions of the crystal array unit and the photoelectric sensor array unit in the first direction and the second direction may be selected according to a design requirement. As shown in FIG. 3, in an embodiment, the photoelectric sensor array unit 210 and the crystal array unit 110 each have equal dimensions in the first direction y and the second direction z, i.e., the projection in the third direction x is square, so that the structures of the photoelectric sensor array unit 210 and the crystal array unit 110 are simple, making it easy to arrange the photoelectric sensors 211 and the crystals 111 and thereby reducing the cost. In other embodiments, the dimensions of the photoelectric sensor array unit 210 or the crystal array unit 110 in the first direction y and the second direction z may be different. For example, the crystal array in the crystal array unit may be 3*3, 4*3, etc.

As shown in FIG. 1 to FIG. 3, in an embodiment, each crystal array unit 110 includes s single crystal 111, each photoelectric sensor array unit 210 includes a single photoelectric sensor 211, and the dimension of the crystal 111 is equal to that of the photoelectric sensor 211.

According to the embodiments of the present disclosure, through the arrangement of the multi-layer crystal arrays, compared with the traditional single-layer crystal array using longer crystals, the dimension of the crystal 111 in the third direction x is smaller, so as to reduce the optical path of the fluorescence photons, thereby reducing the TOF value of the detector and improving sensitivity and detection efficiency of the detector.

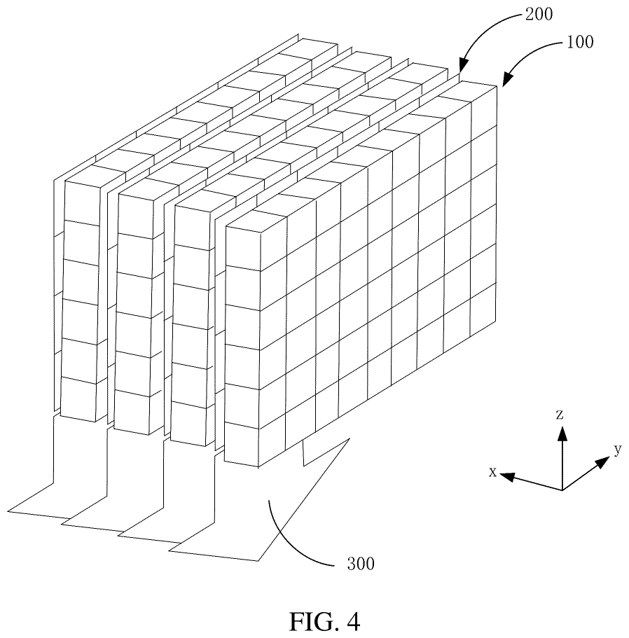

As shown in FIG. 3 and FIG. 4, in an embodiment, each crystal array unit 110 includes a plurality of crystals 111, and the plurality of crystals 111 are arranged in an array in the plane defined by the first direction y and the second direction z. Each photoelectric sensor array unit 210 includes a plurality of photoelectric sensors 211, and the plurality of photoelectric sensors 211 are arranged in an array in the plane defined by the first direction y and the second direction z. The number of the crystals 111 in the crystal array unit 110 is greater than that of the photoelectric sensors 211 in the photoelectric sensor array unit 210. For example, a boundary dimension of a single photoelectric sensor array unit 210 is equal to that of a single crystal array unit 110, where the single photoelectric sensor array unit 210 is an array of 2×2, and the single crystal array unit 110 is an array of 3×3, 4×4, 5×5, etc. It can be understood that the photoelectric sensor array 200 may also be an array of 3×3, and the crystal array unit 110 may also be an array of 4×4, 5×5, etc. In this way, the number of the photoelectric sensors 211 is smaller, thereby reducing the material cost, while the crystal 111 has a smaller dimension, making the optical path smaller and reducing the TOF value.

As shown in FIG. 2 and FIG. 4, in an embodiment, the detector includes multiple layers of crystal arrays 100 and photoelectric sensor arrays 200, with each crystal array 100 corresponding to one photoelectric sensor array 200. The plurality of crystal arrays 100 and the plurality of photoelectric sensor arrays 200 are stacked in the third direction x, and one photoelectric sensor array 200 is stacked between each two adjacent crystal arrays 100. The plurality of crystal arrays and the plurality of photoelectric sensor arrays are alternately stacked in the third direction x, and each crystal array is coupled to one photoelectric sensor array adjacent thereto. Compared with the traditional longer crystals, through the arrangement of the multi-layer crystal array units 110, propagation time and the propagation distance of the fluorescence photons in each crystal 111 are reduced, which improves the temporal resolution of the detector while maintaining a certain sensitivity. At least two crystal arrays 100 are stacked in the third direction x. It is to be noted that, taking gamma photons incident in the direction x as an example, for a basic unit composed of crystal arrays 100 and photoelectric sensor arrays 200 stacked in multiple layers, gamma photons interact with the crystals 111 in the crystal arrays 100, resulting in energy deposition. The crystals 111 in different layers produce scintillation light through the absorption of gamma photons, and the scintillation light can be detected by the corresponding photoelectric sensor arrays 200. The photoelectric sensor array 200 can then determine the crystal position information and the depth of interaction of the gamma photons incident into the crystal array 100 based on the signal strength of the detected scintillation light, and convert the scintillation light into electrons through the photoelectric effect, which are then output in the form of current to the backend electronic circuit system after being amplified step by step. Each layer of photoelectric sensor array 200 is connected to a signal lead-out cable 300, and the signal lead-out cable 300 is connected to the backend electronic circuit system, so that the signals of the photoelectric sensor array 200 are transmitted to the backend electronic circuit system. After necessary amplification of the signal, coincidence addresses of each pair of detectors that form a coincident projection line are accurately identified, and the acquired signal is converted into digital information and sent to a computer for a series of data processing.

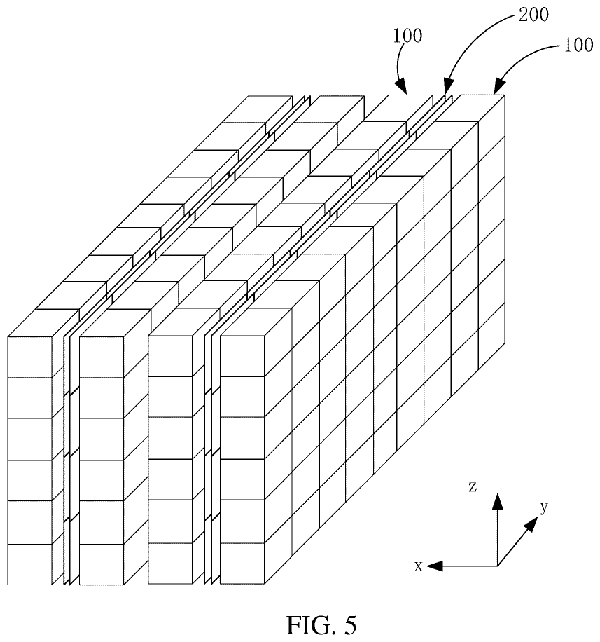

In some other embodiments of the present disclosure, a pair of photoelectric sensor arrays is arranged between at least one pair of adjacent crystal arrays, and the pair of photoelectric sensor arrays is arranged back to back. Referring to the exemplary embodiment shown in FIG. 5, a pair of sensor arrays 200 is arranged between adjacent crystal arrays 100. The pair of sensor arrays 200 is arranged back to back and is respectively coupled to the adjacent crystal arrays 100. The photoelectric sensor array 200 arranged back to back may be respectively arranged on respective circuit boards, or may be arranged on, for example, two sides of a single circuit board.

It may be understood that, in some other embodiments, among the plurality of crystal arrays, there may be a pair of sensor arrays 200 between a pair of adjacent crystal arrays 100, and only one sensor array 200 is arranged between another pair of adjacent crystal arrays 100.

In an embodiment, a plane parallel to the third direction x in the crystal array 100 is configured as an incident plane. Light enters the crystal array 100 in any direction except the third direction x. For example, the light may enter the crystal array 100 along the first direction y and the second direction z, or may enter the crystal array 100 along a direction oblique to the first direction y and the second direction z, and certainly may alternatively enter the crystal array 100 along a direction oblique to the third direction x.

In some other embodiments, the third direction x is used as the incident direction, that is, the plane defined by the first direction y and the second direction z receives gamma photons. At the same time, the photodetector array 200 is configured to reduce the impact on the propagation of gamma photons in the stacked structure.

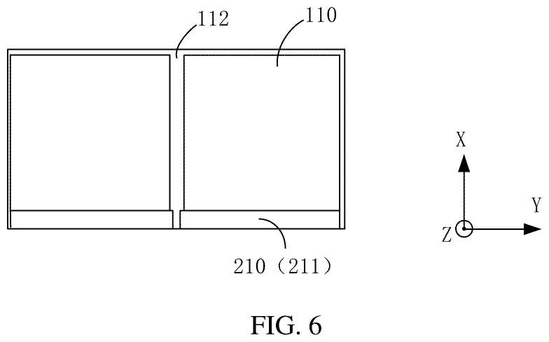

As shown in FIG. 6, in an embodiment, surfaces of each crystal array unit 110 except the coupling surface 101 are provided with a reflection structure 112. The reflection structure 112 may be a reflecting film using plastic die steel, barium sulfate, polytetrafluoroethylene, etc. as a reflecting medium. The reflection structure 112 is arranged on all surfaces of the crystal array unit 110 except the coupling surface 101 to prevent optical crosstalk between adjacent crystal array units 110, thereby improving the performance of the detector and imaging quality of the medical device.

It is to be noted that, in this embodiment, the reflection structure 112 may also be arranged between the crystals in the crystal array unit 110, and the reflection structure is arranged between the crystals on the remaining surfaces of the crystal other than the coupling surface 101. The lengths of the reflection structures 112 may be the same or different.

As shown in FIG. 6, in some embodiments, the reflection structure 112 extends along the third direction x to the photoelectric sensor array unit 210. In some embodiments, the reflection structure 112 extends along the third direction x between two adjacent photoelectric sensor array units 210 and is flush with a side face of the photoelectric sensor array unit 210 away from the crystal array unit. In this way, optical crosstalk between the sensor array elements 210 can be effectively prevented, so as to ensure the performance of the detector and the imaging quality of the medical device.

An embodiment of the present disclosure further provides a medical device. The medical device includes the detector described in the above embodiments. In some embodiments, the detector includes a plurality of crystal arrays 100 and at least one photoelectric sensor array 200. Each crystal array 100 includes a plurality of crystal array units 110, and the plurality of crystal array units 110 are arranged in an array in a plane defined by a first direction y and a second direction z. Each crystal array unit 110 includes at least one crystal 111. The photoelectric sensor array 200 is arranged between at least two adjacent crystal arrays 100, and includes a plurality of photoelectric sensor array units 210 arranged in an array in the plane defined by the first direction y and the second direction z. Each photoelectric sensor array unit 210 includes at least one photoelectric sensor 211. The plurality of crystal arrays 100 are stacked in a third direction x. The crystals are configured to receive gamma photons. The photoelectric sensor 211 is configured to detect optical signals generated by the interaction of the gamma photons and the crystals 111.

In some embodiments, a surface of the detector parallel to the third direction x faces a to-be-detected target, such as a human body. In this way, the surface of the detector receives gamma photons from the to-be-detected target. That is, the surface of the crystal array 100 in the detector receives the gamma photons and converts the gamma photons into fluorescent photons that may be detected by the photoelectric sensor array 200.

The medical device according to the embodiments may be a single positron emission tomography (PET) device of a medical imaging device or a positron emission computed tomography/computed tomography (PET/CT) multi-modal device. The detector above is used in the medical device, and the crystal array 100 is configured to convert incident gamma photons into fluorescent photons. The crystal array 100 is arranged in such a form that the plurality of crystal array units 110 are arranged in an array, so that the crystal has a smaller dimension and the detector has a higher sensitivity and resolution. The crystal array 100 is coupled to the photoelectric sensor array 200 so that the fluorescent photons generated by the interaction of the gamma photons and the crystals are converted into electrical signals by the photoelectric sensor array 200. The number and dimension of the photoelectric sensor array unit 210 are consistent with those of the crystal array unit 110, respectively. The depth information can be artificially separated, so that the photoelectric sensor array units 210 can directly parse the crystal array units 110, which reduces subsequent data correction and directly acquires depth information of the crystal where a scintillation event occurs. The multi-layer crystal array units 110 shorten the propagation time of the gamma photons in the crystal 111 and increase a total propagation length of the gamma photons, which improves the temporal resolution of the detector while maintaining a certain sensitivity. The dimension of the crystal 111 is not greater than that of the photoelectric sensor 211, so that the dimension of the crystal 111 is relatively small, thereby reducing the optical path of the fluorescence photons and the TOF value of the detector and improving the sensitivity and detection efficiency of the detector. At the same time, the number of the photoelectric sensor 211 is smaller or consistent with the number of the crystal 111 to reduce material costs.

In an embodiment, dimensions of the crystal 111 in the first direction y, the second direction z, and the third direction x each range from 0.5 mm to 5 mm. In this way, the crystal has a smaller dimension, so that the detector has a higher sensitivity and resolution.

The technical features of the above embodiments can be combined arbitrarily. In order to make the description concise, not all possible combinations of the technical features are described in the embodiments. However, as long as there is no contradiction in the combination of these technical features, the combinations should be considered within the scope of the specification.

The above embodiments are only several implementations of the present disclosure, and the descriptions are relatively specific and detailed, but they should not be construed as limiting the scope of the present disclosure. It should be understood by those of ordinary skill in the art that various modifications and improvements can be made without departing from the concept of the present disclosure, and all fall within the protection scope of the present disclosure. Therefore, the patent protection of the present disclosure shall be defined by the appended claims.

What is claimed is:

1. A detector, comprising:
a plurality of crystal arrays each comprising a plurality of crystal array units arranged in an array in a plane defined by a first direction and a second direction, each of the crystal array units comprising at least one crystal, each of the crystal arrays having a coupling surface perpendicular to a third direction, wherein the first direction, the second direction, and the third direction are perpendicular to one another; and
a plurality of photoelectric sensor arrays stacked with the plurality of crystal arrays in the third direction, each of the photoelectric sensor arrays comprising a plurality of photoelectric sensor array units arranged in an array in the plane defined by the first direction and the second direction, each of the photoelectric sensor array units comprising at least one photoelectric sensor, the photoelectric sensor array being coupled to the crystal array through the coupling surface.

2. The detector according to claim 1, wherein the plurality of photoelectric sensor array units are in one-to-one correspondence to the plurality of crystal array units, and each of the photoelectric sensor array units has a boundary not exceeding a boundary of the corresponding crystal array unit.

3. The detector according to claim 2, wherein the photoelectric sensor array unit and the crystal array unit each have equal dimensions in the first direction and the second direction.

4. The detector according to claim 3, wherein each of the crystal array units comprises a single crystal, each of the photoelectric sensor array units comprises a single photoelectric sensor, and a dimension of the crystal is equal to that of the photoelectric sensor.

5. The detector according to claim 3, wherein each of the crystal array units comprises a plurality of crystals arranged in an array in the plane defined by the first direction and the second direction, and each of the photoelectric sensor array units comprises a plurality of photoelectric sensors arranged in an array in the plane defined by the first direction and the second direction, a number of the crystals in each of the crystal array units being greater than that of the photoelectric sensors in each of the photoelectric sensor array units.

6. The detector according to claim 1, wherein one of the photoelectric sensor arrays is stacked between each two adjacent crystal arrays.

7. The detector according to claim 1, wherein surfaces of each of the crystal array units except the coupling surface are provided with a reflection structure.

8. The detector according to claim 7, wherein the reflection structure extends to the photoelectric sensor array unit along the third direction.

9. The detector according to claim 8, wherein the reflection structure extends between two adjacent photoelectric sensor array units along the third direction and is flush with a side face of the photoelectric sensor array unit away from the crystal array unit.

10. The detector according to claim 1, wherein dimensions of the crystal in the first direction, the second direction, and the third direction each range from 0.5 mm to 5 mm.

11. The detector according to claim 1, wherein a number of the photoelectric sensor array units is equal to that of the crystal array units, and a dimension of the photoelectric sensor is not less than that of the crystal.

12. The detector according to claim 1, wherein a pair of the photoelectric sensor arrays is arranged between at least one pair of adjacent crystal arrays, the pair of photoelectric sensor arrays being arranged back to back.

13. A medical device, comprising a detector, wherein the detector comprises:
a plurality of crystal arrays each comprising a plurality of crystal array units arranged in an array in a plane defined by a first direction and a second direction, each of the crystal array units comprising at least one crystal, the plurality of crystal arrays being stacked in a third direction, wherein the first direction, the second direction, and the third direction are perpendicular to one another; and
at least one photoelectric sensor array arranged between at least two adjacent crystal arrays in the third direction, the at least one photoelectric sensor array comprising a plurality of photoelectric sensor array units arranged in an array in the plane defined by the first direction and the second direction, each of the photoelectric sensor array units comprising at least one photoelectric sensor;
wherein the crystals are configured to receive gamma photons, and the photoelectric sensors are each configured to detect optical signals generated by interaction of the gamma photons and the crystals.

14. The medical device according to claim 13, wherein dimensions of the crystal in the first direction, the second direction, and the third direction each range from 0.5 mm to 5 mm.

15. The medical device according to claim 14, wherein each of the crystal arrays has a coupling surface perpendicular to the third direction, and the crystal array is coupled to the at least one photoelectric sensor array through the coupling surface.

16. The medical device according to claim 15, wherein surfaces of each of the crystal array units except the coupling surface are provided with a reflection structure.

17. The medical device according to claim 16, wherein the reflection structure extends to the photoelectric sensor array unit along the third direction.

18. The medical device according to claim 13, wherein the at least one photoelectric sensor array comprises a plurality of photoelectric sensor arrays, the plurality of crystal arrays and the plurality of photoelectric sensor arrays being alternately stacked.

19. The medical device according to claim 13, wherein the at least one photoelectric sensor array comprises a pair of photoelectric sensor arrays arranged between one pair of adjacent crystal arrays, the pair of photoelectric sensor arrays being arranged back to back.

20. A detector, comprising a plurality of crystal arrays and a plurality of photoelectric sensor arrays, wherein the plurality of crystal arrays and the plurality of photoelectric sensor arrays are alternately stacked in a direction, and each of the crystal arrays is coupled to one of the photoelectric sensor arrays adjacent thereto.
